(19) United States
(12) Patent Application Publication
(10) Pub. No.: US 2025/0384586 A1
(43) Pub. Date: Dec. 18, 2025

(54) IDENTIFYING AND MANIPULATING COLOR COMPOSITIONS WITHIN DIGITAL IMAGES BASED ON RELATIVE SIGNIFICANCE OF HUE VALUES

(71) Applicant: Adobe Inc., San Jose, CA (US)

(72) Inventors: Dmytro Baranovskiy, Sydney (AU); Gregory Zulkie, Brooklyn, NY (US)

(21) Appl. No.: 18/743,337

(22) Filed: Jun. 14, 2024

(51) Int. Cl. G06T 7/90; G06F 3/04845; G06T 11/00; G06T 11/20

(52) U.S. Cl. CPC G06T 7/90; G06F 3/04845; G06T 11/001; G06T 11/206; G06T 2200/24; G06T 2207/10024

(57) ABSTRACT

The present disclosure relates to systems, non-transitory computer-readable media, and methods for identifying and manipulating color compositions within digital images based on relative significance of hue values. For example, the disclosed systems generate a significance distribution of hue values for a digital image based on comparisons of colors comprising the hue values within the digital image. Based on the significance distribution, the disclosed systems provide, for display via a user interface on a client device, one or more dominant hue values for the digital image in relation to a spectrum of hue values. Further, in some embodiments, the disclosed systems adjust, in response to a user interaction with a target hue value of the one or more dominant hue values, a plurality of colors comprising the target hue value within the digital image.

### BACKGROUND

Recent years have seen significant improvements in digital graphics tools for creating or modifying digital content. In particular, individuals and businesses increasingly utilize digital graphics tools to edit images. Indeed, with increased availability of digital graphics tools via commercial, personal, and mobile devices, many individuals and businesses produce digital images and utilize a variety of digital graphics tools to edit those digital images. Many such digital graphics tools are capable of generating, selecting, and/or modifying a variety of digital design elements within a digital image, including modifying colors of the digital images. However, a number of problems and issues exist with regard to state of the art approaches for intelligent identification and manipulation of color compositions in creating digital content, particularly with regard to flexibility, accuracy, and efficiency of implementing computing devices.

### BRIEF SUMMARY

Embodiments of the present disclosure provide benefits and/or solve one or more of the foregoing or other problems in the art with systems, non-transitory computer-readable media, and methods for identifying and manipulating color compositions within digital images based on relative significance of hue values. To illustrate, the disclosed systems generates a significance distribution of hue values for a digital image based on comparisons of colors comprising the hue values within the digital image. In some embodiments, for example, the disclosed systems determine significance metrics for hue values within a digital image with colors comprising respectively complementary hue values and/or respectively adjacent hue values within the digital image. Additionally, in one or more embodiments, the disclosed systems provide, for display via a user interface on a client device, one or more dominant hue values for the digital image in relation to a spectrum of hue values in a graphical user interface tool for modifying colors of the digital image. Further, in some embodiments, the disclosed systems adjust, in response to a user interaction with a target hue value of the one or more dominant hue values provided via the graphical user interface tool, a plurality of colors comprising the target hue value within the digital image.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a color harmonization system operates in accordance with one or more embodiments.

FIG. 2 illustrates an overview of a color harmonization system determining dominant hue values for a digital image and generating a modified digital image with modified colors in accordance with one or more embodiments.

FIG. 3 illustrates an overview of a color harmonization system generating a significance distribution of hue values for a digital image in accordance with one or more embodiments.

FIG. 4 illustrates an overview of the color harmonization system generating suggestions for color harmonization within a digital image in accordance with one or more embodiments.

FIG. 5 illustrates a digital image including dominant hue values indicated by the color harmonization system in accordance with one or more embodiments.

FIG. 6A illustrates embodiments of graphical user interface tools of a color harmonization system indicating dominant hue values for a digital image in relation to a spectrum of hue values in accordance with one or more embodiments.

FIG. 6B illustrates an exemplary implementation of the color harmonization system utilizing graphical user interface tools to manipulate a color composition of hue values in accordance with one or more embodiments.

FIG. 7 illustrates a schematic diagram of a color harmonization system in accordance with one or more embodiments.

FIG. 8 illustrates a flowchart of a series of acts for identifying one or more dominant hue values for a digital image and manipulating colors comprising a target hue value within the digital image in accordance with one or more embodiments.

FIG. 9 illustrates a flowchart of a series of acts for identifying one or more dominant hue values for a digital image based on significance metrics for hue values of a digital image in accordance with one or more embodiments.

FIG. 10 illustrates a block diagram of an example computing device for implementing one or more embodiments of the present disclosure.

### DETAILED DESCRIPTION

This disclosure describes one or more embodiments of a color harmonization system that identifies and manipulates color compositions within digital images based on relative significance of hue values. In one or more implementations, for example, the color harmonization system processes colors comprising each hue value within a digital image to ascertain a relative significance of each hue value within the digital image. In some embodiments, for example, the color harmonization system assesses the significance of each hue value within a digital image by comparing each hue value to respectively adjacent and/or complementary hue values on a spectrum of hue values (e.g., within the HSL color space). Also, in some embodiments, the color harmonization system considers additional factors in determining significance of hue values within a digital image, such as lightness, chroma, saturation, and proximity to a center of the digital image.

Furthermore, in one or more embodiments, the color harmonization system presents color composition elements of a digital image and provides graphical user interface tools and suggestions for manipulating the color composition via a user interface on a client device. In some embodiments, for example, the color harmonization system provides one or more dominant hue values for a digital image in relation to a spectrum of hue values for display via a graphical user interface on a client device. To further illustrate, in some implementations, the color harmonization system provides indications of the one or more dominant hue values as one or more axes originating at a center of a color wheel comprising a spectrum of hue values. Additionally, in some implementations, the color harmonization system provides, for display within a digital image, one or more color dots respectively associated with the one or more dominant hue values for the digital image at one or more pixel coordinates corresponding to the one or more dominant hue values.

Additionally, in some embodiments, the color harmonization system provides various graphical user interface tools and suggestions for adjusting colors within digital images for color harmonization. In one or more embodiments, for example, the color harmonization system determines one or more suggestions for adjusting dominant hue values within a digital image based on one or more harmonic templates comprising predetermined relationships between colors within a spectrum of hue values. In one or more implementations, for example, one or more suggestions for adjustment of dominant hue values includes an alignment of at least one dominant hue value with a complementary hue value within the spectrum of hue values. To further illustrate, in one or more implementations, to adjust a particular hue value, the color harmonization system 106 modifies colors comprising the particular hue value within a digital image by changing the particular hue value of the colors to an alternate hue value.

In one or more implementations, the disclosed color harmonization system provides a variety of advantages and benefits over conventional systems and methods for identifying and/or modifying color compositions within digital images. For example, many conventional systems fail to provide flexible and intuitive tools for the manipulation of color compositions within digital images. To illustrate, conventional systems often utilize rigid color selection tools that require client devices to iteratively choose individual colors within a digital image for adjustment. Moreover, although some conventional systems determine and manipulate color compositions based on analysis of color values, many such systems rely on segmented sectors of a corresponding color space and/or predetermined color palettes for color analysis and manipulation, failing to provide flexibility for inputs and applications outside of such discrete sectors and/or limited color palettes.

Also, many conventional systems are inefficient and inaccurate in identifying and/or implementing adjustments to color compositions of digital images. As mentioned, for instance, many conventional systems require excessive user interaction to select colors and/or adjust the color composition of a digital image. Furthermore, conventional systems that utilize limited color palettes and/or segmented color spaces fail to accurately identify and align color compositions for harmonization of colors within digital images. For example, color space sectors often fail to accurately represent color composition of a digital image, as a given sector potentially encompasses two or more distinct and independently dominant hue values within the digital image. Moreover, conventional systems require excessive time, user interactions, user interfaces, and/or computing resources (e.g., storage and memory) in identifying, presenting, and manipulating color compositions of digital images.

For instance, in contrast to conventional systems that segment images into sectors of a color space or limited color palettes for image decomposition, the color harmonization system improves accuracy by leveraging the relative significance of hue values based on a comprehensive analysis of colors within a digital image to determine dominant hue values for the digital image. For instance, by generating and utilizing a significance distribution of hue values for a digital image, the color harmonization system more accurately identifies and implements adjustments to dominant hue values to achieve greater color harmonization within the digital image. Furthermore, in one or more implementations the color harmonization system identifies color compositions within an image with increased efficiency compared to conventional systems, such as systems that require palette extraction during image decomposition. Indeed, compared to extraction of specialized color palettes and corresponding per-pixel color mixing weights, as many such systems require, embodiments of the color harmonization system utilize an algorithmic approach to evaluate image colors and determine dominant hue values in a fraction of the time.

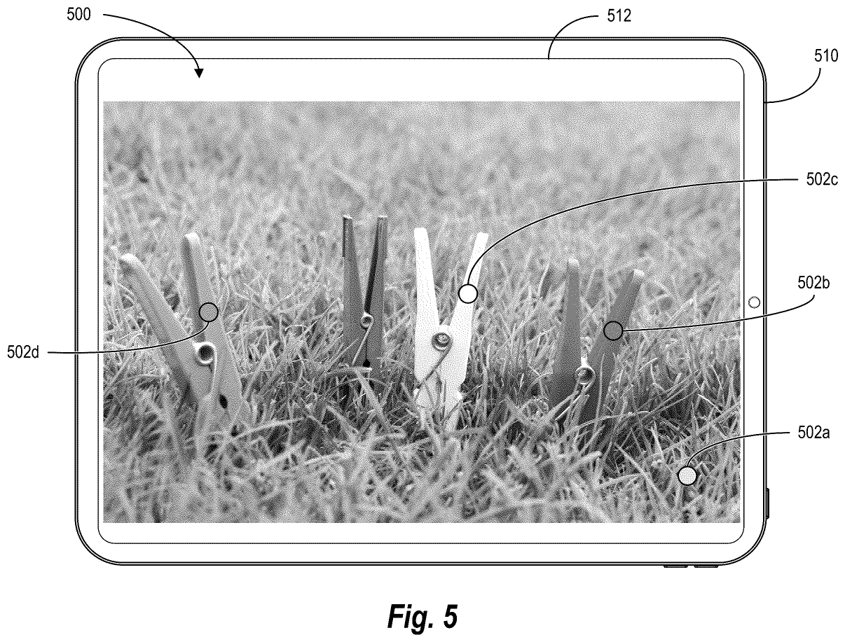

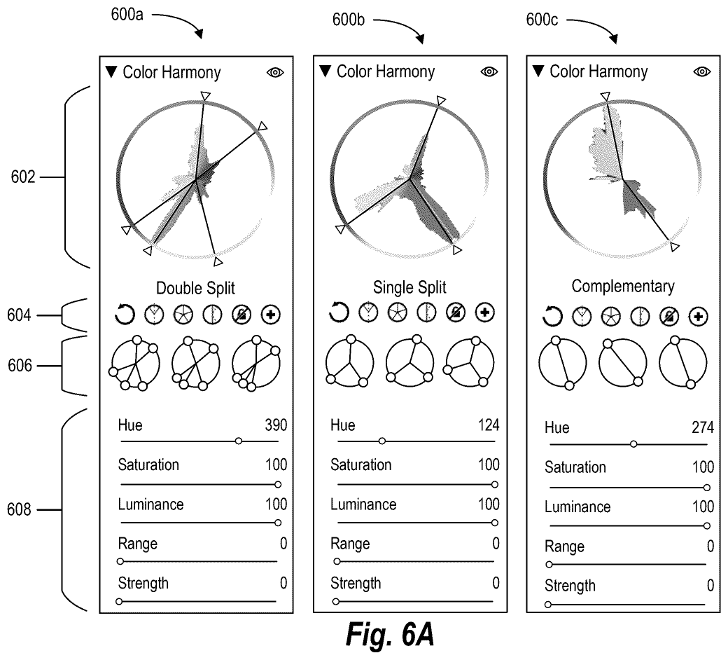

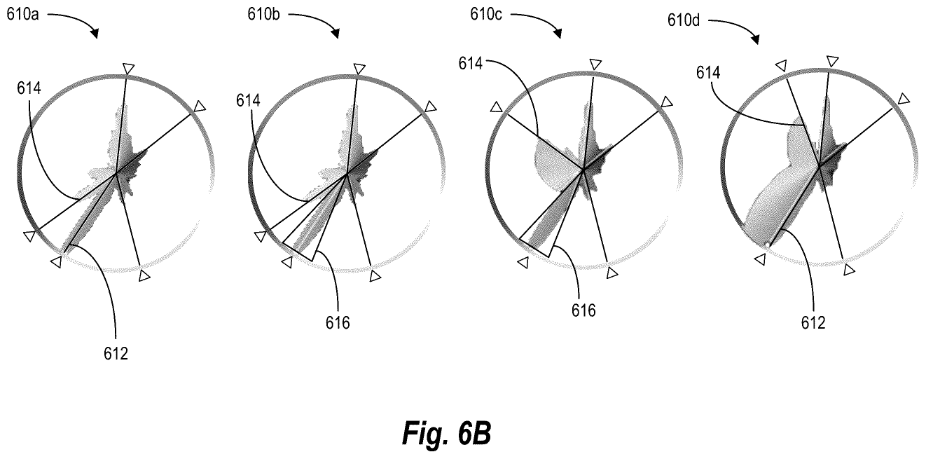

In addition to improved accuracy and efficiency in identifying color compositions within digital images, the color harmonization system provides user interface elements and tools capable of manipulating color compositions within digital images with increased flexibility compared to conventional systems. For example, many existing systems rely on vectorscopes to visually inspect color saturation levels across frames of a video for inspection and manipulation of the overall color composition of video images. In contrast, the color harmonization system provides tools with intuitive displays of dominant hue values in relation to a spectrum of hue values, such as the user interface examples provided in FIGS. 5-6B. Indeed, embodiments of the color harmonization system include user interfaces, editing tools, and intuitive suggestions for color harmonization that significantly improve the flexibility with which color compositions within digital images are manipulated.

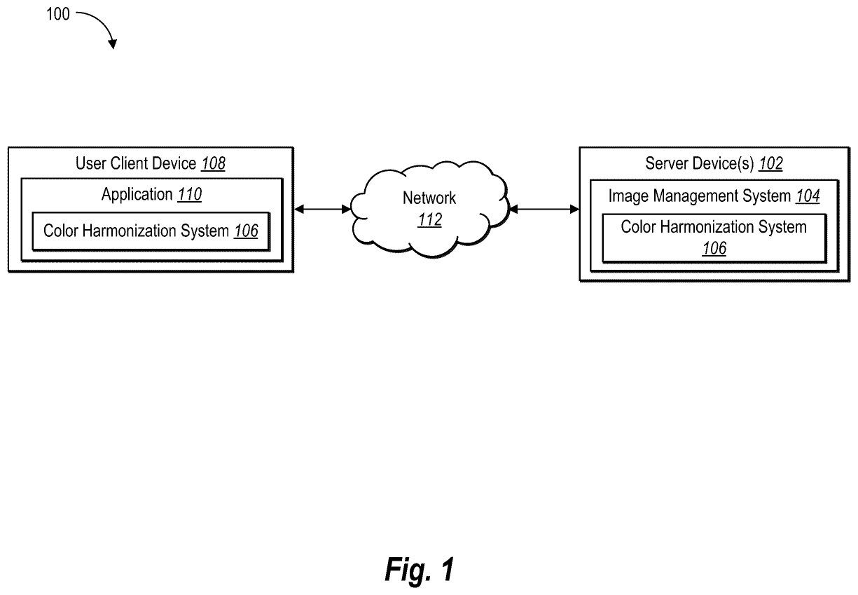

Turning now to the figures, FIG. 1 illustrates a schematic diagram of one embodiment of an environment 100 (or system) in which a color harmonization system 106 operates in accordance with one or more embodiments. As illustrated, the environment 100 includes one or more server device(s) 102 connected to a user client device 108 via a network 112. While FIG. 1 shows an embodiment of the color harmonization system 106, alternative embodiments and configurations are possible.

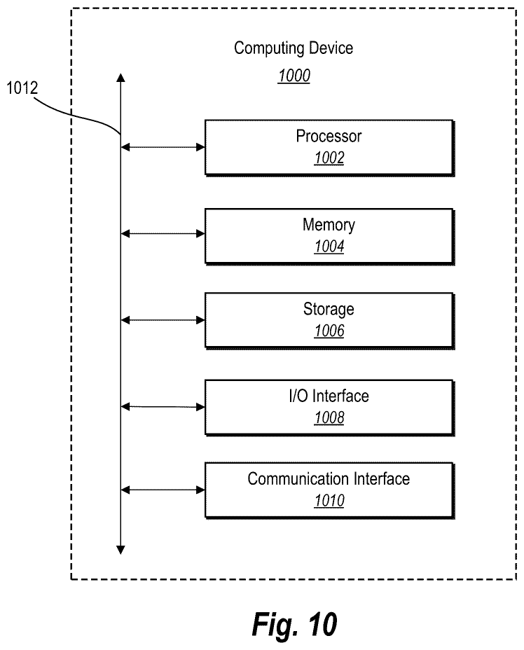

As shown in FIG. 1, the server device(s) 102 and the user client device 108 are connected via the network 112. As shown, in one or more implementations, each of the components of the environment 100 communicate via the network 112. The network 112 comprises a suitable network over which computing devices are able to communicate. Example networks are discussed in additional detail below in relation to FIG. 10.

As shown, the environment 100 includes the server device(s) 102. The server device(s) 102 generates, stores, receives, and/or transmits digital information including digital images, color harmony templates, model parameters, etc. In particular, in one or more implementations, the server device(s) 102 provides digital information via web pages or native application to devices such as the user client device 108. The server device(s) 102 is able to communicate with the user client device 108 via the network 112. For example, the server device(s) 102 gathers and/or receives digital information including digital images, metadata, and/or user customizations from the user client device 108. In some embodiments, the server device(s) 102 also send user interface information and/or suggestions for image modifications to the user client device 108. In some embodiments, the server device(s) 102 comprise a distributed server where the server device(s) 102 include a number of server devices distributed across the network 112 and located in different physical locations. The server device(s) 102 optionally comprises a content server, an application server, a communication server, a web-hosting server, or a digital content management server.

As further shown in FIG. 1, the server device(s) 102 includes an image management system 104 that generates, collects, provides, stores, modifies, enhances, and/or displays digital images. In some embodiments, the image management system 104 provides tools for generating, editing, storing, sharing, or otherwise interacting with digital images via various graphical user interfaces and/or applications (e.g., application 110 of the user client device 108). In one or more embodiments, the image management system 104 comprises a color harmonization system 106 that communicates digital information over the network 112. The image management system 104 also performs various backend functions associated with the identification and manipulation of color compositions within digital images in connection with identifying and displaying dominant hue values of the digital images. As illustrated in FIG. 1, the color harmonization system 106 is implemented as part of the image management system 104.

As illustrated in FIG. 1, the environment 100 includes the user client device 108. In some embodiments, the user client device 108 generates, stores, receives, and sends digital data. For example, the user client device 108 communicates with the server device(s) 102 via the network 112. In some embodiments, the user client device 108 illustrated in FIG. 1 comprises various types of client devices. For example, in some embodiments, the user client device 108 is a mobile device such as a laptop, tablet, mobile telephone, smartphone, etc. In other embodiments, the user client device 108 includes non-mobile devices, such as desktops, or other types of client devices. In some examples, the user client device 108 comprises an augmented reality device or a virtual reality device. Additional details regarding the computing devices, of which the user client device 108 is one implementation, are discussed below with respect to FIG. 10.

The user client device 108 is optionally associated with a user or user account of an image design and modification platform managed by the image management system 104. For instance, the user client device 108 is associated with a creator of digital images. Additionally, the user client device 108 is optionally associated with a user who is creating and/or editing a digital image via the image management system 104. As mentioned, the user client device 108 communicates with the server device(s) 102. In particular, the user client device 108 uploads and sends digital data including digital images to the server device(s) 102 via the network 112. Additionally, the user client device 108 displays graphical user interfaces including visualizations of color compositions and suggestions for color harmonization (e.g., as described below in relation to FIGS. 5-6B).

As illustrated in FIG. 1, the user client device 108 includes the application 110. In various embodiments, the application 110 includes a web application or a native application on the user client device 108 (e.g., a mobile application, a desktop application, etc.). The application 110 interfaces with the color harmonization system 106 to provide digital content including digital images, graphical user interfaces, and modified digital images to the device(s) 102. In one or more implementations, the application 110 is a browser that renders a graphical user interface on the display of the user client device 108. For example, the application 110 renders graphical user interfaces for receiving user modifications to the color composition of a digital image (e.g., an adjustment to colors of a target hue value or implementation of a suggested harmony template).

Although FIG. 1 depicts the color harmonization system 106 located on the server device(s) 102, in some embodiments, the color harmonization system 106 is implemented by (e.g., located entirely or in part) one or more other components of the environment 100. In some embodiments, the color harmonization system 106 is implemented entirely (or in part) on the user client device 108. Moreover, although the environment 100 includes a single user client device 108, in one or more embodiments, the environment 100 includes multiple user client devices and client devices. For example, the environment 100 include a first user client device 108 associated with a user who creates and/or modifies a digital image. The environment 100 also optionally includes a second user client device 108 associated with a user who views and/or further modifies the digital image. Additionally, the user client device 108 optionally communicates directly with the color harmonization system 106, bypassing the network 112. Furthermore, in some embodiments, the color harmonization system 106 accesses or more databases housed on the server device(s) 102 or elsewhere in the environment 100.

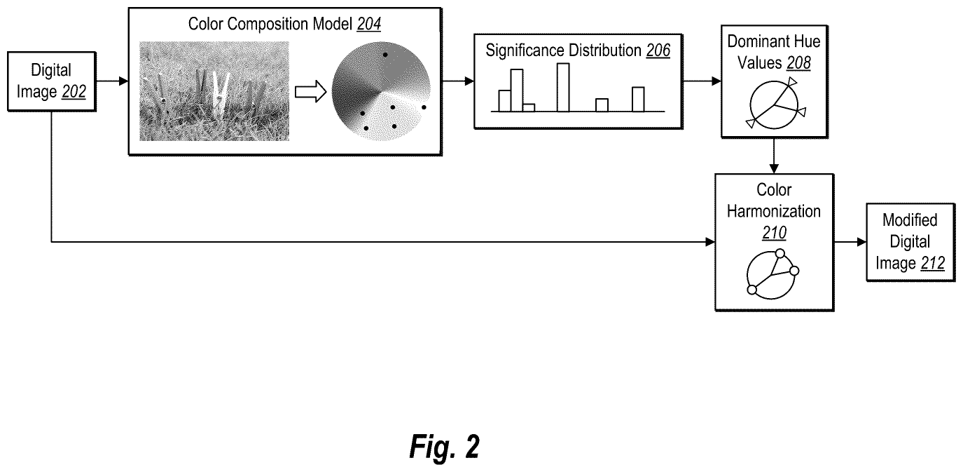

While FIG. 1 illustrates an example environment in which the color harmonization system 106 operates, the following figures and corresponding discussion provide additional detail regarding how the color harmonization system 106 identifies and manipulates color compositions of digital images in accordance with one or more embodiments. For instance, FIG. 2 illustrates an overview of the color harmonization system 106 determining dominant hue values 208 for a digital image 202 and generating a modified digital image 212 implementing a color harmonization 210 of the dominant hue values 208.

As illustrated in FIG. 2, the color harmonization system 106 identifies (or receives) the digital image 202 comprising a plurality of colors. In some implementations, for example, the plurality of colors of the digital image 202 include multiple colors (e.g., colored pixels) of various hue values, chroma values, and/or lightness values within a hue/chroma/lightness (HSL) color space. Indeed, in some embodiments, an image includes, but is not limited to, a digital file with the following extensions: JPEG, TIFF, BMP, PNG, RAW, or PDF. In addition, in certain instances, an image includes a digital frame of a digital video. In particular, in one or more embodiments, an image includes a digital frame within, but not limited to, a digital file with the following extensions: MP4, MOV, WMV, or AVI.

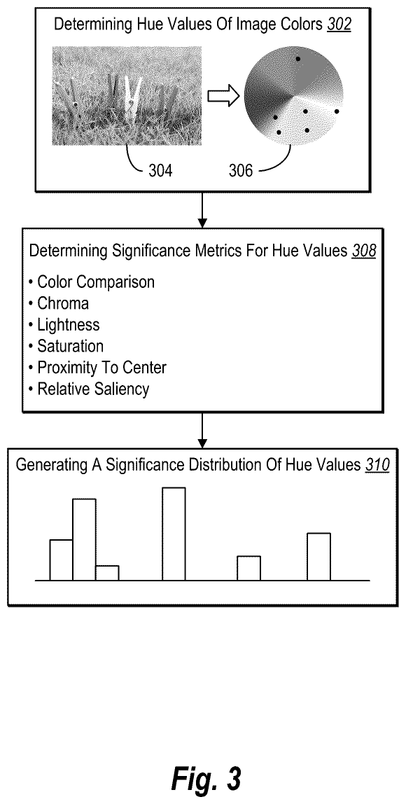

As shown, the color harmonization system 106 utilizes a color composition model 204 to identify the plurality of colors within the digital image 202 (e.g., to determine the hue values, chroma values, and/or lightness values of each color of the plurality of colors within the digital image 202). Further, in one or more embodiments, the color harmonization system 106 determines a significance metric for each hue value included in the plurality of colors based on comparisons between colors of different hue values within the digital image and, in some cases, based on additional factors of significance (e.g., as described in further detail below in relation to FIG. 3).

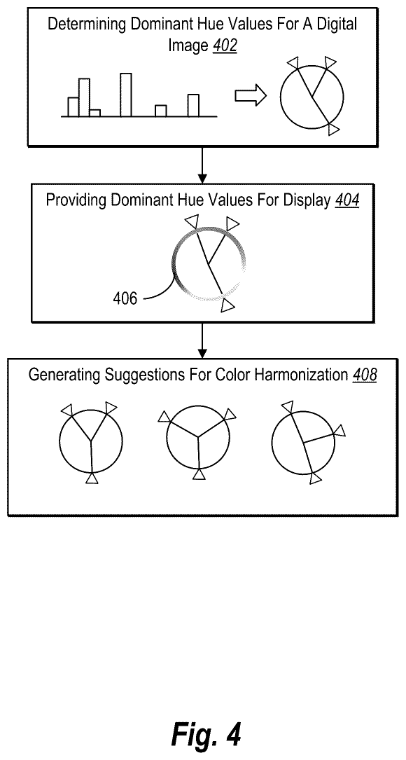

As also shown in FIG. 2, the color harmonization system 106 utilizes the color composition model 204 to generate a significance distribution 206 of hue values within the digital image 202. In one or more implementations, for example, the significance distribution 206 comprises a distribution of significance metrics (e.g., as represented by a histogram or other statistical illustration) for the respective hue values within the digital image 202. Based on the significance distribution 206, the color harmonization system 106 determines the one or more dominant hue values 208 for the digital image 202 (e.g., as further described below in relation to FIG. 4).

Having determined the dominant hue values 208 for the digital image 202 based on the significance distribution 206 of hue values, the color harmonization system 106 provides tools and/or suggestions for the color harmonization 210 of the digital image 202. In some implementations, for example, the color harmonization 210 includes adjusting colors comprising at least one target hue of the dominant hue values within the digital image 202 to generate the modified digital image 212. As a further example, in some implementations, the color harmonization includes adjusting colors of one or more target hue values in accordance with a harmonic template (e.g., as further described below in relation to FIG. 4).

As mentioned, in some embodiments, the color harmonization system 106 utilizes a color composition model to generate a significance distribution of hue values for colors within a digital image. For example, FIG. 3 illustrates an overview of the color harmonization system 106 generating a significance distribution of hue values for a digital image 304.

As illustrated in FIG. 3, the color harmonization system 106 performs an act 302 of determining hue values of image colors within the digital image 304. As shown, the color harmonization system 106 determines hue values of image colors with respect to a color space 306 comprising a spectrum of hue values and other color attributes (e.g., saturation and lightness). Indeed, in some embodiments, a color space includes a distribution of colors comprising hue values and other color attributes, such as but not limited to the hue, saturation, and lightness (HSL) color space, the Commission Internationale de l'Éclairage Lab (CIELAB) color space, the ProPhoto RGB color space, the Adobe RGB color space, and so forth. In some embodiments, the color harmonization system 106 converts colors of a digital image from a first color space (e.g., CIELAB) to a second color space (e.g., HSL) including hue values, or vice versa. Accordingly, the color harmonization system 106 determines hue values and, in some cases, other color attributes of the plurality of colors within the digital image 304 for evaluation of a relative significance of hue values within the digital image 304.

As further shown in FIG. 3, the color harmonization system 106 performs an act 308 of determining significance metrics for hue values. In some embodiments, for example, the color harmonization system 106 compares colors of each hue value with colors comprising one or more respectively complementary hue values or respectively adjacent hue values within the digital image. For instance, in certain embodiments, the color harmonization system 106 compares colors of a particular hue value h with colors of a complementary hue value within a spectrum of hue values 306 (e.g., h+180 within the HSL color space). Additionally or alternatively, in certain embodiments, the color harmonization system 106 compares colors of the particular hue value h with colors of one or more adjacent hue values within the spectrum of hue values 306. In some implementations, for example, the color harmonization system 106 considers adjacent hue values determined by adding or subtracting a predetermined constant to the particular hue value h within the HSL color space (e.g., h+45 and/or h−45). In other embodiments, the particular hue value h is greater than or less than 45.

In one or more embodiments, the color comparison step of the act 308 includes determining a distance metric between colors comprising the hue values within the digital image 304 with colors comprising the one or more respectively complementary or respectively adjacent hue values within the digital image 304. To illustrate, in some embodiments, the color harmonization system 106 determines a distance measurement between colors of a particular hue value and colors within the digital image 304 comprising a respectively complementary hue value or a respectively adjacent hue value according to the following:

$$\vert Δ L \vert + \sqrt{{( {a}_{1} - {a}_{2} )}^{2} + {( {b}_{1} - {b}_{2} )}^{2}}$$

where |ΔL| represents a difference in lightness values and \sqrt{(a₁−a₂)²+(b₁−b₂)²} represents a Euclidean distance in a color space (e.g., a CIELAB color space) between respective colors. Further, in some embodiments, the color harmonization system 106 normalizes the distance measurements for colors within the digital image 304 by dividing each respective measurement by a normalization constant, such as an expected maximum value (e.g., 100+\sqrt{220²+220²}≈411) according to possible values of the lightness and/or hue/chroma values in the color space.

Additionally, in some embodiments, the color harmonization system 106 filters the plurality of colors within the digital image 304 to exclude colors having a lightness value or a chroma value below a predetermined threshold (or outside of a predetermined threshold range) from the foregoing distance measurements. Accordingly, in one or more embodiments, the color harmonization system 106 averages the distance measurement between colors of a particular hue value and one or more respectively complementary hue values or respectively adjacent hue values within the digital image to generate a distance metric M for the particular hue value and determines a significance metric for the particular hue value based in whole or in part on the distance metric M.

Additionally or alternatively, as shown in FIG. 3, the color harmonization system 106 determines significance metrics for hue values within the digital image 304 based on one or more of the relative chroma values, lightness values, or saturation values of colors comprising the respective hue values. As mentioned, in some embodiments, the color harmonization system 106 excludes colors comprising a lightness value or a chroma value below a predetermined threshold or within a predetermined range when determining significance metrics. In some implementations, for example, the color harmonization system 106 excludes colors comprising a chroma value below a predetermined threshold (e.g., a threshold of 0.025). Similarly, in some implementations, the color harmonization system 106 excludes colors comprising a lightness value above a predetermined threshold of 0.99 and/or below a predetermined threshold (e.g., a threshold of 0.2). Also, in some embodiments, the color harmonization system 106 excludes colors otherwise determined to be relatively insignificant within the digital image 304 (e.g., as selected by a user).

As also shown in FIG. 3, in some embodiments, the color harmonization system 106 determines significance metrics for hue values within the digital image 304 based on a relative proximity of colors respectively comprising the hue values to a center (e.g., a geometric center) or a focal point (e.g., a center of interest defined by objects, shapes, colors, patterns, etc.) of the digital image 304. In one or more embodiments, for example, the color harmonization system 106 determines or adjusts the significance metrics for hue values within the digital image 304 according to the following:

$$b = exp ( - \frac{{π}^{2} {d}^{2}}{20 {r}^{2}} ) + 1$$

where b represents a proximity component or weight of a color comprising a particular hue, d represents a distance to a center or focal point of the digital image, and r represents a radius of the largest circle that fits within the digital image with a location of the color at the center of the largest circle (e.g., as determined by r=min(w/2, h/2), where w and h represent the digital image's width and height, respectively). Thus, the color harmonization system 106 assigns (e.g., weights) higher significance metrics to hue values located closer to the center of the digital image than to hue values located farther away from the center of the digital image.

Moreover, in some embodiments, the color harmonization system 106 combines various color attributes (e.g., such as those described above) to determine significance metrics for hue values within the digital image 304. To illustrate, in one or more embodiments, the color harmonization system 106 determines a significance metric for a particular hue value according to the following:

$$Significance = Mb + 5 cls$$

where M represents a distance metric (e.g., determined by comparing colors of different hue values as described above), b represents a proximity metric or weight (e.g., as described above), and c, l, and s respectively represent chroma values, lightness values, and saturation values for colors comprising the particular hue value.

As further indicated in FIG. 3, in one or more embodiments, the color harmonization system 106 determines or adjusts significance metrics for hue values within the digital image 304 based on respective locations of colors comprising the hue values within the digital image according to a saliency map of the digital image. In some embodiments, for example, a saliency map for a digital image comprises a representation of the digital image that highlights the regions of an image or scene that are most likely to attract human attention. In some embodiments, for example, the color harmonization system 106 utilizes a saliency map to determine focal points of an image for determining proximity metrics or weights as described above. To illustrate, the color harmonization system 106 generates the saliency map based on user indicated regions of the digital image or automatically via an image processing neural network (e.g., an object recognition neural network) that identifies foreground/background regions of the digital image.

Also, as shown in FIG. 3, the color harmonization system 106 performs an act 310 of generating a significance distribution of hue values for the digital image 304. In some embodiments, for example, the color harmonization system 106 categorizes hue values into bins spanning one or more hue values per bin (e.g., three or more consecutive hue values or three degrees of hue values for each bin within the spectrum of hue values 306 of the HSL color space). Accordingly, in one or more embodiments, the color harmonization system 106 constructs a histogram representing the significance distribution of hue values within the digital image 304 according to the significance metrics. Also, in some embodiments, the color harmonization system 106 implements a smoothing algorithm, such as Gaussian kernel smoothing, to reduce fluctuations within the histogram representing the significance distribution.

As mentioned, in some embodiments, the color harmonization system 106 determines dominant hue values for a digital image, provides the dominant hue vales for display on a client device, and generates one or more suggestions for color harmonization of the digital image via adjustment of the dominant hue values. For example, FIG. 4 illustrates an overview of the color harmonization system determining dominant hue values for a digital image, providing the dominant hue values for display, and generating suggestions for color harmonization of a digital image.

As shown in FIG. 4, for instance, the color harmonization system 106 performs an act 402 of determining dominant hue values for a digital image based on a significance distribution (e.g., a significance distribution generated by the color harmonization system 106 as described above in relation to FIG. 3). In one or more embodiments, the color harmonization system 106 selects the one or more dominant hue values for the digital image by identifying one or more distinct spikes in the corresponding significance distribution (e.g., prominent peaks in a histogram representing the significance distribution) for the digital image. For example, the color harmonization system 106 determines that a hue value (or a bin or an adjacent set of bins of hue values) is a dominant hue value (e.g., belongs to a spike) in response to determining that the hue value has a value greater than its neighboring hue values (or bins) by a threshold. In some embodiments, the color harmonization system 106 also determines that a hue value (or a bin or an adjacent set of bins of hue values) is a dominant hue value in response to determining that the hue value has at least a threshold value relative to a maximum hue value in addition to comparing the hue value to its neighbors. Alternatively, in some embodiments, the color harmonization system 106 selects the one or more dominant hue values by identifying hue values within the significance distribution comprising respective significance metrics above a predetermined threshold.

As also shown in FIG. 4, the color harmonization system 106 performs an act 404 of providing the dominant hue values (e.g., identified during the act 402) for display via a user interface of a client device (e.g., the client user device 108). As illustrated, the color harmonization system 106 presents (e.g., provides for display) the dominant hue values in relation to a spectrum of hue values, such as a color wheel 406 representing the spectrum of hue values in a relative color space. In some implementations, for example, the color wheel 406 comprises a ring of colors represent 360 degrees of hue values within the HSL color space. As also illustrated, the color harmonization system 106 displays (or provides for display) the dominant hue values as respective axes protruding from a center of the color wheel 406, thus presenting the dominant hue values in perspective with one another and with the spectrum of hue values represented by the color wheel 406. In some embodiments, the color harmonization system 106 also displays a circular histogram of hue values present within the digital image inside the color wheel 406, such that the hue values radiate outward from the center of the color wheel 406 to display the spikes corresponding to dominant hue values in connection with the axes. Additionally, in some embodiments, the color harmonization system 106 provides the dominant colors for display in relation to a spectrum of hue values within a different color space (e.g., a CIELAB color space or an alternative thereof).

As further illustrated in FIG. 4, the color harmonization system 106 performs an act 408 of generating suggestions for color harmonization of the digital image comprising the dominant hue values determined via the act 402 and presented via the act 404. As shown, for instance, the color harmonization system 106 presents (e.g., provides for display) one or more suggestions for adjusting the dominant hue values according to one or more predetermined harmonic templates. In some embodiments, for example, a predetermined harmonic template comprises a relative arrangement of axes representing dominant hue values within a color space represented by a color wheel (e.g., as further described below in relation to FIG. 6). Indeed, in some implementations, the color harmonization system 106 presents one or more axes respectively corresponding to one or more dominant hue values for a digital image in a color wheel representing the spectrum of hue values with one or more selectable preset configurations of the one or more axes. Alternatively or additionally, the color harmonization system 106 provides suggestions and/or tools for individual adjustment of the dominant hue values, location-targeted adjustment of hue values within the digital image, and/or introduction of an additional hue value within the digital image (e.g., to replace neutral grays, whites, or blacks within the digital image.

As mentioned, in some embodiments, the color harmonization system 106 presents color composition elements of a digital image and provides tools and suggestions for manipulating the color composition via a user interface on a client device. For example, FIGS. 5-6B illustrate implementations of the color harmonization system 106 presenting color composition elements (e.g., dominant hue values) and providing tools and/or suggestions for manipulating the presented color composition elements within the corresponding digital images via a user interface on a client device. More specifically, FIG. 5 illustrates the color harmonization system 106 providing indications of dominant hue values within a digital image, FIG. 6A illustrates the color harmonization system 106 providing indications of dominant hue values for digital images in relation to a spectrum of hue values within a color space, and FIG. 6B illustrates the color harmonization system 106 manipulating dominant hue values for a digital image utilizing one or more graphical user interface tools.

As shown in FIG. 5, the color harmonization system 106 provides for display on a client device 510 (e.g., within a user interface 512 of an application for editing digital images) a digital image 500 comprising a plurality of colors of a variety of hue values. In response to identifying multiple dominant hue values for the colors within the digital image 500 (e.g., as described above in relation to FIGS. 2-4), the color harmonization system 106 provides multiple respective color dots 502a-502d for display in relation to the dominant hue values within the digital image 500. In particular, as shown in FIG. 5, the color harmonization system 106 provides, for display within the digital image 500 via the user interface 512 on the client device 510, the color dots 502a-502d respectively associated with the one or more dominant hue values within the digital image 500. To illustrate, the color harmonization system determines one or more pixel coordinates corresponding to the one or more dominant hue values and displays the color dots 502a-502d at the one or more pixel coordinates.

To determine the pixel coordinates corresponding to the one or more dominant hue values, in one or more embodiments, the color harmonization system 106 iterates through pixels of the digital image 500 until arriving at a respective pixel coordinate for each dominant hue of the one or more dominant hue values. In some embodiments, for example, the color harmonization system 106 determines, for a particular pixel within the digital image 500, whether a threshold number of pixels surrounding the particular pixel (e.g., in a circle centered at the particular pixel) comprise an individual dominant hue value of the one or more hue values. In response to determining that the threshold number of pixels surrounding the particular pixel include the dominant hue value, the color harmonization system 106 selects the coordinate of the particular pixel. Alternatively, in some embodiments, the color harmonization system 106 evaluates and compares each pixel comprising a particular dominant hue value within the digital image 500 to select a pixel comprising a greatest quantity of surrounding pixels comprising the particular hue value.

As illustrated in FIG. 5, the color dot 502a indicates a green hue value in relation to grass portrayed in the digital image 500 with a hue value corresponding to a substantially green hue, the portrayed grass comprising colors of various saturation and lightness values. Accordingly, the color harmonization system 106 provides the color dot 502a indicating a green hue value at a pixel coordinate corresponding to the grass within the digital image 500.

As also illustrated, the color dot 502b indicates a red hue value in relation to a first clothing pin (e.g., the first clothing pin from the right) portrayed in the digital image 500 with a hue value corresponding to a substantially red hue, the corresponding first clothing pin comprising colors of various saturation and lightness values. Accordingly, the color harmonization system 106 provides the color dot 502b indicating a red hue value at a pixel coordinate corresponding to the first clothing pin within the digital image 500.

Moreover, the color dot 502c indicates a yellow hue value in relation to a second clothing pin (e.g., the second clothing pin from the right) portrayed in the digital image 500 with a hue value corresponding to a substantially yellow hue, the corresponding second clothing pin comprising colors of various saturation and lightness values. Accordingly, the color harmonization system 106 provides the color dot 502c indicating a yellow hue value at a pixel coordinate corresponding the second clothing pin within the digital image 500.

Additionally, the color dot 502d indicates a blue hue value for colors comprising a substantially blue hue within the digital image 500, such as the colors of a third clothing pin and a fourth clothing pin (e.g., the third and fourth clothing pins from the right, respectively) within the digital image 500. Accordingly, the color harmonization system 106 provides the color dot 502d indicating a blue hue value at a pixel coordinate corresponding to one of the third clothing pin or the fourth clothing pin within the digital image 500.

As shown in FIG. 6A, the color harmonization system 106 provides, for display via a user interface on a client device, color composition interfaces 600a-600c for three respective digital images. Specifically, each of the color composition interfaces 600a-600c includes representation 602 of dominant hue values for each respective digital image as axes within a color wheel representing a spectrum of hue values. Further, each of the color composition interfaces 600a-600c includes respective sets of hue value selection tools 604, harmonization suggestions 606, and color manipulation tools 608 for adjustment of the respective dominant hue values within each respective digital image.

In the illustrated embodiment, the hue value selections tools 604 of the color composition interfaces 600a-600c include various selectable icons providing intuitive tools for selection and manipulation of hue values displayed in relation to a color wheel within the representation 602. Accordingly, in response to a user interaction with any of the hue value selection tools 604 and corresponding interactions with at least one target hue value portrayed in the representation 602, the color harmonization system 106 adjusts colors comprising the at least one target hue value within the corresponding digital image.

As shown, for instance, the hue value selection tools 604 include a first selectable icon (e.g., an undo icon) for reversing a previous change to the corresponding digital image. Also, the hue value selection tools 604 include a second selectable icon for aligning two target hue values relative to a central axis on the color wheel of the representation 602, such as a third hue value positioned between the two target hue values on the color wheel. Further, the hue value selection tools 604 include a third selectable icon for aligning all hue values within the representation 602 at an equal distance relative to one another on the color wheel (e.g., with an equal angle between respective axes of the portrayed hue values). Additionally, the hue value selection tools 604 include a fourth selectable icon for fixing two target hue values in a complementary alignment relative to the color wheel of the representation 602. Moreover, the hue value selection tools 604 include a fifth selectable icon for locking a relative position of a target hue value as adjustments are implemented with respect to other hue values portrayed within the representation 602. In addition, the hue value selection tools 604 include a sixth selectable icon for adding an additional axis indicating a dominant hue value not included in the one or more dominant hue values provided by the color harmonization system 106 within the representation 602. In some embodiments, in response to adding the hue value (e.g., via interaction with the sixth selectable icon), the color harmonization system 106 provides updated harmonization suggestions 606 for the hue values portrayed in the representation 602.

Furthermore, the color manipulation tools 608 of the color composition interfaces 600a-600c include selectable adjustment tools for modifying various characteristics of a selected hue value (e.g., a target hue value within the corresponding representation 602). As shown, for instance, the color manipulation tools 608 include a first selectable adjustment tool for altering the hue value, a second selectable adjustment tool for altering a saturation level, and a third selectable adjustment tool for altering a luminance level of colors comprising a target hue value (or a range of target hue values) within the corresponding digital image. Also, the color manipulation tools 608 include a fourth selectable adjustment tool for increasing a range of hue values represented by a particular axis of the representation 602, such that subsequent interactions with the particular axis implement adjustments to every hue value within the adjusted range of hue values. In addition, the color manipulation tools 608 include a fifth selectable adjustment tool for adjusting the relative strength of a target hue value in colors comprising the target hue value within the corresponding digital image (e.g., by reducing variation in saturation and lightness between the colors comprising the target hue value within the corresponding digital image).

To further illustrate, the representation 602 of the color composition interface 600a indicates a double split composition of five dominant hue values for the corresponding digital image in relation to the spectrum of hue values. Accordingly, the harmonization suggestions 606 of the color composition interface 600a include three distinct selectable hue value configurations for modifying the relative alignment of the five dominant hue values with one or more predetermined harmonic templates comprising a double split composition of hue values. Although FIG. 6A illustrates three specific configurations of double split compositions of hue values, in other embodiments, the color harmonization system 106 provides more or fewer suggestions corresponding to more or fewer predetermined harmonic templates.

As also illustrated, the representation 602 of the color composition interface 600b indicates a single split composition of three dominant hue values for the corresponding digital image in relation to the spectrum of hue values. Accordingly, the harmonization suggestions 606 of the color composition interface 600b include three distinct selectable hue value configurations for modifying the relative alignment of the three dominant hue values with one or more predetermined harmonic templates comprising a single split composition of hue values. Although FIG. 6A illustrates three specific configurations of single split compositions of hue values, in other embodiments, the color harmonization system 106 provides more or fewer suggestions corresponding to more or fewer predetermined harmonic templates.

Also, as illustrated, the representation 602 of the color composition interface 600c indicates a potential for a complementary composition of two dominant hue values for the corresponding digital image in relation to the spectrum of hue values. Accordingly, the harmonization suggestions 606 of the color composition interface 600c include three distinct selectable hue value configuration for modifying the relative alignment of the two dominant hue values in a predetermined harmonic template comprising a complementary composition of hue values. Although FIG. 6A illustrates three specific configurations of complementary compositions of hue values, in other embodiments, the color harmonization system 106 provides more or fewer suggestions corresponding to more or fewer predetermined harmonic templates.

Moreover, in some embodiments, the color harmonization system 106 generates suggestions for harmonization based on relative positions of axes corresponding to dominant hue values within a digital image in relation to a color wheel representing a spectrum of hue values. For example, in one or more embodiments, the color harmonization system 106 determines one or more angular adjustments of axes representing dominant hues to align with a predetermined harmonic template. Further, in some embodiments, the color harmonization system 106 determines multiple potential adjustments of the axes corresponding to dominant hue values and provides one or more selectable suggestions for display via a user interface on a user device (e.g., three suggestions for adjustment of hue values within a digital image, such as illustrated in FIG. 6). In one or more embodiments, for example, the color harmonization system 106 selects for suggestion a subset of the multiple potential adjustment requiring the least change in hue value to arrive at the respectively suggested harmonic template. In various embodiments, the color harmonization system 106 considers adjustments to dominant hue values within a digital image to implement one or more of (i) a line symmetry between axes representing the dominant hue values, (ii) adjusting hue values corresponding to one or more particular axes to become complements of other axes representing other dominant hue values, or (iii) distributing axes corresponding to the dominant hue value around the color wheel representing the spectrum of hue values, thus approaching an equal spread or distribution of dominant hue values within the digital image.

As mentioned, FIG. 6B illustrates an exemplary implementation of the color harmonization system 106 utilizing graphical user interface tools (e.g., the hue value selection tools 604 and/or the color manipulation tools 608) to manipulate a color composition of hue values within a digital image. In the example shown, the color harmonization system 106 initially provides a first representation 610a of dominant hue values for a digital images as axes within a color wheel representing a spectrum of hue values. As shown, the first representation 610a comprises five axes representing dominant hue values, including a first axis 612 and a second axis 614. In response to a user interaction with the first representation 610a, the color harmonization system 106 generates and portrays a range of hue values 616 about the first hue value 612 within a second representation 610b, fixing the range of hue values in position during subsequent interactions with the representation 610b.

In response to a user interaction with the second hue value 614 within the representation 610b, the color harmonization system 106 adjusts the relative position of the second hue value 614 while maintaining the respective positions of hue values within the fixed range of hue values 616 and portrays a third representation 610c illustrating the modification. Accordingly, as shown in the third representation 610c, the color harmonization system 106 adjusts hue values affected by the modification of the second hue value 614 without altering colors within the fixed range 616. In contrast, when adjusting the second hue value 614 without implementation of the fixed range 616 about the first hue value 612, the color harmonization system 106 provides a representation 610d wherein hue values surrounding both the second hue value 614 and the first hue value 612 are altered due to the adjustment of the second hue value 614.

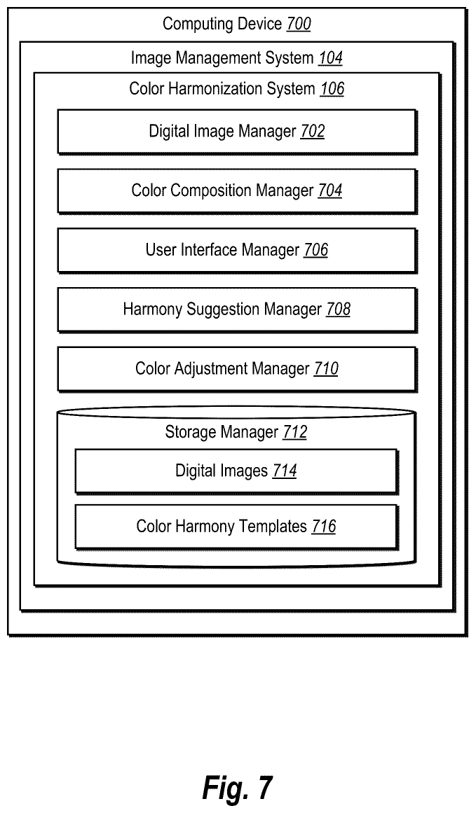

Turning now to FIG. 7, additional detail will be provided regarding components and capabilities of one or more embodiments of the color harmonization system 106. In particular, FIG. 7 illustrates an example color harmonization system 106 executed by a computing device 700 (e.g., the server devices(s) 102 or the client device 108). As shown by the embodiment of FIG. 7, the computing device 700 includes or hosts the image management system 104 and the color harmonization system 106. Furthermore, as shown in FIG. 7, the color harmonization system 106 includes, but is not limited to, a digital image manager 702, a color composition manager 704, a user interface manager 706, a harmony suggestion manager 708, a color adjustment manager 710, and a storage manager 712. Additionally, the storage manager 712 manages storage of digital images 714 and color harmony templates 716. Each of the components mentioned above is described below in turn.

As just mentioned, and as illustrated in the embodiment of FIG. 7, the color harmonization system 106 includes the digital image manager 702. For instance, the digital image manager 702 identifies, stores, transmits, and/or displays digital images (and/or digital videos) as described above (e.g., in relation to FIGS. 1-6).

Furthermore, in one or more implementations, the color harmonization system 106 utilizes a color composition model to identify dominant hue values within digital images based on the relative significance of hue values therein. In some embodiments, for instance, the color composition manager 704 implements a color composition model to generate a significance distribution of hue values for a digital image and identify one or more dominant hue values within the digital image based on the significance distribution. Moreover, the color harmonization system 106, via the color composition model, determines significance metrics for hue values of colors within a digital image to generate a significance distribution of the hue values based on comparisons of colors comprising the hue values within the digital image.

In some implementations, the color harmonization system 106 utilizes the user interface manager 706 to provide color composition information for display on a client device (e.g., the user client device 108). In some embodiments, for instance, the user interface manager 706 provides, for display via a user interface on a client device, one or more dominant hue values for a digital image in relation to a spectrum of hue values, such as a color wheel. In addition to the dominant hue values, in some embodiments, the user interface manager 706 provides, for display via the user interface on the client device, one or more harmonization suggestions, selectable harmonization presets, and/or selectable tools for adjustment of the dominant hue values within the digital image (e.g., as described above in relation to FIGS. 5-6.

Relatedly, in some implementations, the color harmonization system 106 utilizes the harmony suggestion manager 708 to determine harmony suggestions for adjusting colors comprising one or more dominant hue values within a digital image. In some embodiments, for example, the harmony suggestion manager 708 compares the dominant hue values of a digital image with the color harmony templates 716 stored by the storage manager 712 to determine harmony suggestions for the digital image (e.g., as described above in relation to FIG. 4).

Moreover, in some implementations, the color harmonization system 106 utilizes the color adjustment manager 710 to implement adjustments to colors comprising at least one target hue value within a digital image (e.g., in accordance with a harmony suggestion provided by the harmony suggestion manager 708). In some embodiments, for example, the color adjustment manager 710 adjusts a target hue value within a digital image by modifying colors within the digital image which comprise the target hue value (e.g., changing the hue value of the colors from the target hue value to an alternative hue value).

In one or more implementations, the color harmonization system 106 utilizes the storage manager 712 to implement various data stores required for the disclosed methods, such as the digital images 714, the color harmony templates 716, significance distributions generated for digital images, parameters utilized in determining and/or manipulating color compositions of digital images, and so forth. In some implementations, the color harmonization system 106 receives a digital image from a client device or other source and utilizes the storage manager 712 to store the received digital image (e.g., as one of the digital images 714).

Each of the components 702-716 of the color harmonization system 106 include software, hardware, or both. For example, the components 702-716 include one or more instructions stored on a computer-readable storage medium and executable by processors of one or more computing devices, such as a client device or server device. When executed by the one or more processors, the computer-executable instructions of the color harmonization system 106 causes the computing device(s) 700 to perform the methods described herein. Alternatively, the components 702-716 include hardware, such as a special-purpose processing device to perform a certain function or group of functions. Alternatively, the components 702-716 of the color harmonization system 106 include a combination of computer-executable instructions and hardware.

Furthermore, the components 702-716 of the color harmonization system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 702-716 may be implemented as a stand-alone application, such as a desktop or mobile application. Furthermore, the components 702-716 may be implemented as one or more web-based applications hosted on a remote server. The components 702-716 may also be implemented in a suite of mobile device applications or “apps.” To illustrate, the components 702-716 may be implemented in an application, including but not limited to ADOBE PHOTOSHOP, ADOBE LIGHTROOM, ADOBE EXPRESS, or ADOBE CREATIVE CLOUD. “ADOBE,” “ADOBE PHOTOSHOP,” “ADOBE LIGHTROOM,” “ADOBE EXPRESS,” and “ADOBE CREATIVE CLOUD” are either registered trademarks or trademarks of Adobe Systems Incorporated in the United States and/or other countries.

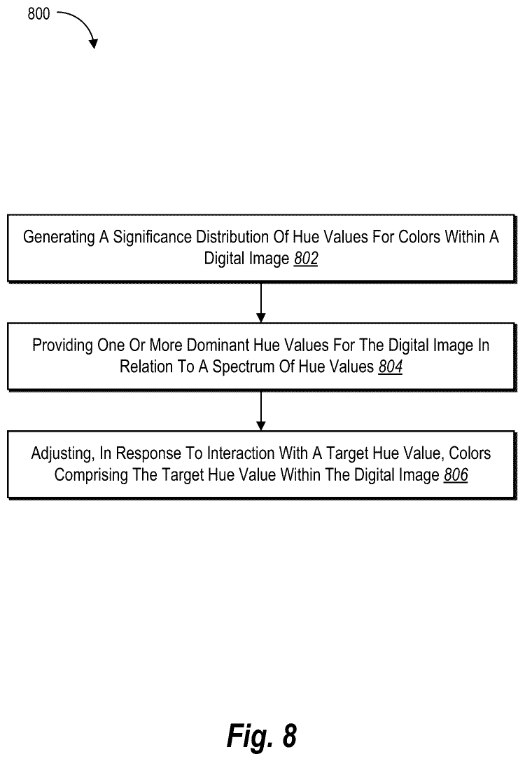

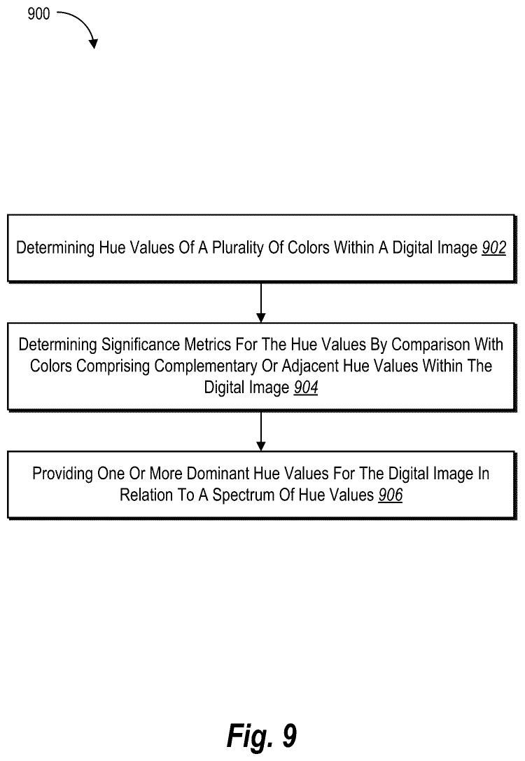

FIGS. 1-7, the corresponding text, and the examples provide a number of different methods, systems, devices, and non-transitory computer-readable media of the color harmonization system 106. In addition to the foregoing, one or more embodiments are also described in terms of flowcharts comprising acts for accomplishing a particular result, as shown in FIGS. 8-9. The acts shown in FIGS. 8-9 may be performed in connection with more or fewer acts. Further, the acts may be performed in differing orders. Additionally, the acts described herein may be repeated or performed in parallel with one another or parallel with different instances of the same or similar acts. A non-transitory computer-readable medium comprises instructions that, when executed by one or more processors, cause a computing device to perform the acts of FIGS. 8-9. In some embodiments, a system is configured to perform the acts of FIGS. 8-9. Alternatively, the acts of FIGS. 8-9 are performed as part of a computer-implemented method.

As mentioned above, FIGS. 8 and 9 illustrate flowcharts of respective series of acts 800 and 900 for implementing the color harmonization system 106. In particular, FIG. 8 illustrates the series of acts 800 for identifying one or more dominant hue values for a digital image and manipulating colors comprising a target hue value within the digital image in accordance with one or more embodiments and FIG. 9 illustrates the series of acts 900 for identifying one or more dominant hue values for a digital image based on significance metrics for hue values of a digital image in accordance with one or more embodiments. While FIGS. 8-9 illustrate acts according to particular embodiments, alternative embodiments may omit, add to, reorder, and/or modify any acts shown in FIGS. 8-9.

As shown in FIG. 8, the series of acts 800 includes an act 802 of generating a significance distribution of hue values for colors within a digital image, an act 804 of providing one or more dominant hue values for the digital image in relation to a spectrum of hue values, and an act 806 of adjusting, in response to interaction with a target hue value, colors comprising the target hue value within the digital image.

For example, in one or more implementations, the series of acts 800 includes: generating a significance distribution of hue values for a digital image based on comparisons of colors comprising the hue values within the digital image, providing, for display via a user interface on a client device and based on the significance distribution, one or more dominant hue values for the digital image in relation to a spectrum of hue values, and adjusting, in response to a user interaction with a target hue value of the one or more dominant hue values, a plurality of colors comprising the target hue value within the digital image.

In some implementations, the series of acts 800 also includes. In one or more implementations, the series of acts 800 also includes presenting the one or more dominant hue values for the digital image in relation to the spectrum of hue values by providing, for display via the user interface on the client device, the one or more dominant hue values in relation to a color wheel comprising the spectrum of hue values. Also, in one or more implementations, the series of acts also includes generating indications of the one or more dominant hue values as one or more axes originating at a center of the color wheel comprising the spectrum of hue values.

Moreover, in one or more implementations, the series of acts 800 also includes. Also, in some implementations, the series of acts 800 includes providing, for display within the digital image via the user interface on the client device, one or more color dots respectively associated with the one or more dominant hue values within the digital image with one or more pixel coordinates corresponding to the one or more dominant hue values. Also, in one or more implementations, the series of acts 800 includes adjusting the target hue value comprises fixing two or more selected hue values relative to one another within the spectrum of hue values while altering colors comprising the target hue value within the digital image.

In some implementations, the series of acts 800 also includes providing, for display via the user interface on the client device, one or more suggestions for adjustment of the one or more dominant hue values within the digital image. Further, in one or more implementations, the one or more suggestions for adjustment of the one or more dominant hue values comprise one or more harmonic templates comprising predetermined relationships between colors within the spectrum of hue values. Moreover, in one or more implementations, at least one of the one or more suggestions for adjustment of the one or more dominant hue values comprise an alignment of at least one of the one or more dominant hue values with a complementary hue value within the spectrum of hue values.

Furthermore, in one or more implementations, the series of acts 800 includes generating the significance distribution of hue values for the digital image comprises determining significance metrics for the hue values by comparing colors comprising the hue values within the digital image with colors comprising one or more respectively complementary hue values or respectively adjacent hue values within the digital image. Also, in some implementations, the series of acts 800 includes adjusting the significance metrics for the hue values based on one or more of a chroma, a lightness, a saturation, or a relative proximity to a center or a focal point of colors comprising the hue values within the digital image. Also, in one or more implementations, the series of acts 800 includes adjusting the significance metrics for the hue values based on respective locations of colors comprising the hue values within the digital image according to a saliency map of the digital image.

In some implementations, the series of acts 800 includes generating the significance distribution by determining significance metrics for the hue values based on the comparisons of colors comprising the hue values within the digital image and generating a histogram of the significance metrics spanning the spectrum of hue values. Also, in one or more implementations, the series of acts 800 also includes providing the one or more dominant hue values for the digital image by providing, for display via the user interface, one or more axes respectively corresponding to the one or more dominant hue values in a color wheel representing the spectrum of hue values with one or more selectable preset configurations of the one or more axes.

As shown in FIG. 9, the series of acts 900 includes an act 902 of determining hue values of a plurality of colors within a digital image, and act 904 of determining significance metrics for the hue values by comparison with colors comprising complementary or adjacent hue values of the digital image, and an act 906 of providing one or more dominant hue values for the digital image in relation to a spectrum of hue values.

For example, in one or more implementations, the series of acts 900 includes: determining hue values of a plurality of colors within a digital image, determining significance metrics for the hue values by comparing colors comprising the hue values within the digital image with colors comprising one or more respectively complementary hue values or respectively adjacent hue values within the digital image, and providing, for display via a user interface on a client device and based on the significance metrics, one or more dominant hue values for the digital image.

In some implementations, the series of acts 900 also includes determining a first respectively adjacent hue value for a particular hue value by adding a predetermined constant to the particular hue value and determining a second respectively adjacent hue value for the particular hue value by subtracting the predetermined constant from the particular hue value. Also, in one or more implementations, the series of acts 900 includes weighting the significance metrics for the hue values based on a respective proximity of colors comprising the hue values within the digital image to a center of the digital image or a focal point of the digital image.

Further, in one or more implementations, the series of acts 900 includes weighting the significance metrics for the hue values based on one or more of a chroma value, a lightness value, or a saturation value of colors comprising the hue values within the digital image. Moreover, in some implementations, the series of acts 900 also includes determining the significance metrics for the hue values further by filtering the plurality of colors within the digital image to exclude colors having a lightness value or a chroma value below a predetermined threshold.

In some implementations, the series of acts 900 also includes generating a significance distribution of the hue values for the digital image based on the significance metrics, selecting the one or more dominant hue values for the digital image based on the significance distribution, and providing, for display via the user interface on the client device, the one or more dominant hue values for the digital image in relation to a spectrum of hue values.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., computing device 1000, server device(s) 102, and client device 108). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating a significance distribution of hue values for a digital image based on comparisons of colors comprising the hue values within the digital image;
providing, for display via a user interface on a client device and based on the significance distribution, one or more dominant hue values for the digital image in relation to a spectrum of hue values; and
adjusting, in response to a user interaction with a target hue value of the one or more dominant hue values, a plurality of colors comprising the target hue value within the digital image.

2. The computer-implemented method of claim 1, wherein presenting the one or more dominant hue values for the digital image in relation to the spectrum of hue values comprises providing, for display via the user interface on the client device, the one or more dominant hue values in relation to a color wheel comprising the spectrum of hue values.

3. The computer-implemented method of claim 2, further comprising generating indications of the one or more dominant hue values as one or more axes originating at a center of the color wheel comprising the spectrum of hue values.

4. The computer-implemented method of claim 1, further comprising providing, for display within the digital image via the user interface on the client device, one or more color dots respectively associated with the one or more dominant hue values within the digital image with one or more pixel coordinates corresponding to the one or more dominant hue values.

5. The computer-implemented method of claim 1, further comprising providing, for display via the user interface on the client device, one or more suggestions for adjustment of the one or more dominant hue values within the digital image.

6. The computer-implemented method of claim 5, wherein the one or more suggestions for adjustment of the one or more dominant hue values comprise one or more harmonic templates comprising predetermined relationships between colors within the spectrum of hue values.

7. The computer-implemented method of claim 5, wherein at least one of the one or more suggestions for adjustment of the one or more dominant hue values comprise an alignment of at least one of the one or more dominant hue values with a complementary hue value within the spectrum of hue values.

8. The computer-implemented method of claim 1, wherein adjusting the target hue value comprises fixing two or more selected hue values relative to one another within the spectrum of hue values while altering colors comprising the target hue value within the digital image.

9. A system comprising:
one or more memory devices; and
one or more processors coupled to the one or more memory devices that cause the system to perform operations comprising:
determining hue values of a plurality of colors within a digital image;
determining significance metrics for the hue values by comparing colors comprising the hue values within the digital image with colors comprising one or more respectively complementary hue values or respectively adjacent hue values within the digital image; and
providing, for display via a user interface on a client device and based on the significance metrics, one or more dominant hue values for the digital image.

10. The system of claim 9, wherein determining the significance metrics for the hue values further comprises:
determining a first respectively adjacent hue value for a particular hue value by adding a predetermined constant to the particular hue value; and
determining a second respectively adjacent hue value for the particular hue value by subtracting the predetermined constant from the particular hue value.

11. The system of claim 9, the operations further comprising weighting the significance metrics for the hue values based on a respective proximity of colors comprising the hue values within the digital image to a center of the digital image or a focal point of the digital image.

12. The system of claim 9, the operations further comprising weighting the significance metrics for the hue values based on one or more of a chroma value, a lightness value, or a saturation value of colors comprising the hue values within the digital image.

13. The system of claim 9, wherein determining the significance metrics for the hue values further comprises filtering the plurality of colors within the digital image to exclude colors having a lightness value or a chroma value below a predetermined threshold.

14. The system of claim 9, the operations further comprising:
generating a significance distribution of the hue values for the digital image based on the significance metrics;
selecting the one or more dominant hue values for the digital image based on the significance distribution; and
providing, for display via the user interface on the client device, the one or more dominant hue values for the digital image in relation to a spectrum of hue values.

15. A non-transitory computer-readable medium storing instructions thereon that, when executed by at least one processor, cause the at least one processor to perform operations comprising:
generating a significance distribution of hue values for a digital image based on comparisons of colors comprising the hue values within the digital image;
providing, for display via a user interface on a client device and based on the significance distribution, one or more dominant hue values for the digital image in relation to a spectrum of hue values; and
adjusting, in response to a user interaction with a target hue of the one or more dominant hue values, a plurality of colors comprising the target hue within the digital image.

16. The non-transitory computer-readable medium of claim 15, wherein generating the significance distribution of hue values for the digital image comprises determining significance metrics for the hue values by comparing colors comprising the hue values within the digital image with colors comprising one or more respectively complementary hue values or respectively adjacent hue values within the digital image.

17. The non-transitory computer-readable medium of claim 16, the operations further comprising adjusting the significance metrics for the hue values based on one or more of a chroma, a lightness, a saturation, or a relative proximity to a center or a focal point of colors comprising the hue values within the digital image.

18. The non-transitory computer-readable medium of claim 16, the operations further comprising adjusting the significance metrics for the hue values based on respective locations of colors comprising the hue values within the digital image according to a saliency map of the digital image.

19. The non-transitory computer-readable medium of claim 15, wherein generating the significance distribution comprises:
determining significance metrics for the hue values based on the comparisons of colors comprising the hue values within the digital image; and
generating a histogram of the significance metrics spanning the spectrum of hue values.

20. The non-transitory computer-readable medium of claim 15, wherein providing the one or more dominant hue values for the digital image comprises providing, for display via the user interface, one or more axes respectively corresponding to the one or more dominant hue values in a color wheel representing the spectrum of hue values with one or more selectable preset configurations of the one or more axes.
